(19) United States
(12) Patent Application Publication
(10) Pub. No.: US 2011/0230065 A1
(43) Pub. Date: Sep. 22, 2011

(54) CONNECTOR HOUSING WITH LIGHT GUIDE ELEMENT

(75) Inventors: Bert Bergner, Bensheim (DE); Werner Boeck, Gross Umstadt (DE); Martin Szelag, Bickenbach (DE)

(73) Assignee: Tyco Electronics AMP GmbH, Benshiem (DE)

(21) Appl. No.: 13/132,756

(22) PCT Filed: Nov. 25, 2009
(86) PCT No.: PCT/EP09/65809

§ 371 Date: Jun. 3, 2011

(30) Foreign Application Priority Data
Dec. 4, 2008 (DE) DE 102008060430.5

(51) Int. Cl. H01R 3/00; H01R 12/00

(52) U.S. Cl. 439/55; 439/488

(57) ABSTRACT

A connector housing according to the invention has at least one connector for electrical connection with a complementary plug-in element, a base, which is designed for mounting on a printed circuit board, and a light guide arranged in or on the connector housing. The light guide terminates flush with the bottom of the base provided for mounting on the printed circuit board or projects therebeyond. An arrangement according to the invention comprises a printed circuit board with at least one via, at least one luminescent element for emitting electromagnetic radiation and at least one connector housing with at least one light guide for receiving and guiding electromagnetic radiation. The connector housing is arranged in such a way on a first side of the printed circuit board and the luminescent element is arranged in such a way on a second side of the printed circuit board that the luminescent element, when switched on, radiates through the via in the printed circuit board into the light guide.

The invention relates to a connector housing with a light guide element and to an arrangement consisting of such a connector housing, a printed circuit board and a luminescent element.

Connector housings are known from EP 0740370 A1 in which a light source in the form of a light-emitting diode is accommodated in the rear part of the housing. In addition, a light guide element is provided, for absorbing light output by the light-emitting diode and guiding it to the front of the connector housing. A user of such connector housings is restricted to the light source integrated into the connector housing and cannot combine the connector housing with any desired light source.

EP 0878872 A2, U.S. 5,876,239 and EP 0945933 A2 disclose connector housings with at least one integrated light guide element, in which light-emitting diodes are mounted and soldered as separate components on the same side of a printed circuit board under the connector housing. When using such connector housings, two mounting steps are necessary in order firstly to mount the light-emitting diodes and then the connector housing on the printed circuit board.

The problem therefore arises of providing a connector housing with at least one integrated light guide element, wherein the connector housing may be combined with any desired luminescent elements and is suitable for simple mounting on printed circuit boards.

The invention relates to a connector housing according to independent claim 1 and to an arrangement according to independent claim 12.

A connector housing according to the invention comprises at least one connector for electrical connection with a complementary plug-in element, a base, which is designed for mounting on a printed circuit board, and a light guide arranged in or on the connector housing. In this case, one end face of the light guide terminates flush with the side of the base provided for mounting on the printed circuit board or projects therebeyond.

An arrangement according to the invention comprises a printed circuit board having at least one via, at least one luminescent element for emitting electromagnetic radiation or light radiation and at least one connector housing with at least one light guide for receiving and guiding electromagnetic radiation. In this case, the connector housing is mounted in such a way on a first side of the printed circuit board and the luminescent element is mounted in such a way on a second side of the printed circuit board that the radiation emitted by the luminescent element passes at least in part through the via in the printed circuit board into one end of the light guide.

As a result of arranging according to the invention the connector housing and the luminescent element on two different sides of the printed circuit board, the connector housing may be combined with any desired luminescent elements. An integrated connector housing may thus be provided, which may be combined as desired with any desired luminescent elements. Furthermore, each side of the printed circuit board may be fully populated in a single process step. In particular, surface-mounted (SMT) components may be used and mounted on each side in each case in a single reflow process. Additional wave soldering processes are not needed here.

Because, in a connector housing according to the invention, the light guide terminates flush with the side of the base provided for mounting on the printed circuit board or projects therebeyond, it is ensured that the radiation which is emitted by the luminescent element arranged on the other side of the printed circuit board is coupled reliably and without large losses into the light guide, i.e. absorbed and passed on thereby.

In one embodiment at least one opening is provided in the base of the connector housing and the light guide extends through this opening. In this case, the light guide fits flush into the opening, such that the opening is completely closed and sealed by the light guide. This reliably prevents moisture or dirt particles from penetrating into the inside of the connector housing and impairing the quality of the plug connection.

In one embodiment the base of the connector housing is provided with at least one electrical terminal for electrical contacting with the printed circuit board. In this way, the connector housing may be mounted particularly simply and reliably on the printed circuit board and connected electrically with conductor tracks arranged on the printed circuit board.

In a further embodiment the connector housing takes the form of a surface-mounted (SMT) component. Surface-mounted components may be mounted particularly simply and inexpensively on a printed circuit board.

In one embodiment the at least one connector takes the form of a socket for accommodating a complementary plug connector. In particular, the connector housing takes the form of an RJ11 or RJ45 connector housing. RJ11 and RJ45 connector housings are connector housings which are used frequently in telecommunications and in which it is particularly desirable to incorporate light guide elements for indicator purposes.

In one embodiment the light guide extends to a top of the connector housing located opposite the base. Thus electromagnetic radiation emitted by the luminescent element and passed on by the light guide may be readily observed and perceived from above the connector housing.

In an alternative embodiment the light guide is bent within the connector housing and extends to a side wall of the connector housing. In one embodiment the light guide extends to the side of the connector housing in which a connector is provided for receiving a complementary plug-in element. The radiation emitted by the luminescent element and absorbed and passed on by the light guide may thus be observed from the side of the connector housing and in particular from the side into which a plug-in element may be introduced.

In a further embodiment a plurality of light guides are provided in the connector housing. In such a connector housing the radiation from a plurality of luminescent elements may be transmitted separately and guided to the outside for indicator purposes, such that a plurality of items of information, for example in different colours, may be conveyed simultaneously to an observer.

In a further embodiment a plurality of connectors are provided in the connector housing. With such a connector housing a plurality of connectors may be produced compactly and just one connector housing has to be mounted on the printed circuit board in order to be able to produce a plurality of plug connections.

In a further embodiment the luminescent element takes the form of a surface-mounted (SMT) component. In this way, the luminescent element may be mounted particularly simply and inexpensively on the printed circuit board.

In a further embodiment the luminescent element is a light-emitting diode. Light-emitting diodes are particularly inexpensive, energy-saving, reliable luminescent elements.

In a further embodiment the light-emitting diode takes the form of a reverse light-emitting diode. Such a reverse light-emitting diode outputs electromagnetic radiation in the direction of the component side. The light-emitting diode may therefore be mounted particularly simply on the opposite side of the printed circuit board from the connector housing in such a way that it irradiates one end of the light guide.

In a further embodiment of an arrangement according to the invention, the connector housing comprises a plurality of light guides and a plurality of luminescent elements are provided which are arranged such that each luminescent element radiates into a different light guide. Through such an arrangement a plurality of indicator functions may be realised simultaneously.

In a further embodiment the light guide is arranged at least in part within the via formed in the printed circuit board. In this way, particularly reliable, low-loss transmission of the radiation emitted by the luminescent element to the light guide is achieved.

In a further embodiment the luminescent element is arranged at least in part within the via formed in the printed circuit board. In this way, particularly reliable, low-loss transmission of the radiation emitted by the luminescent element to the light guide is achieved.

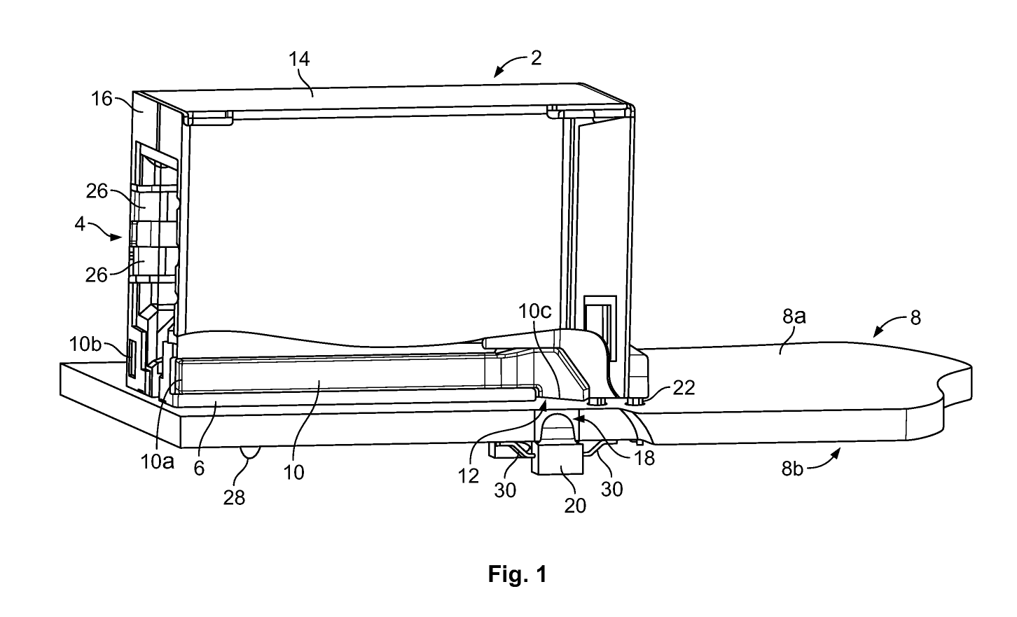

The invention is explained in greater detail below with reference to the exemplary embodiments shown in FIGS. 1 to 6.

FIG. 1 is a perspective partially sectional view of an arrangement according to the invention with a printed circuit board, a luminescent element and a connector housing according to the invention.

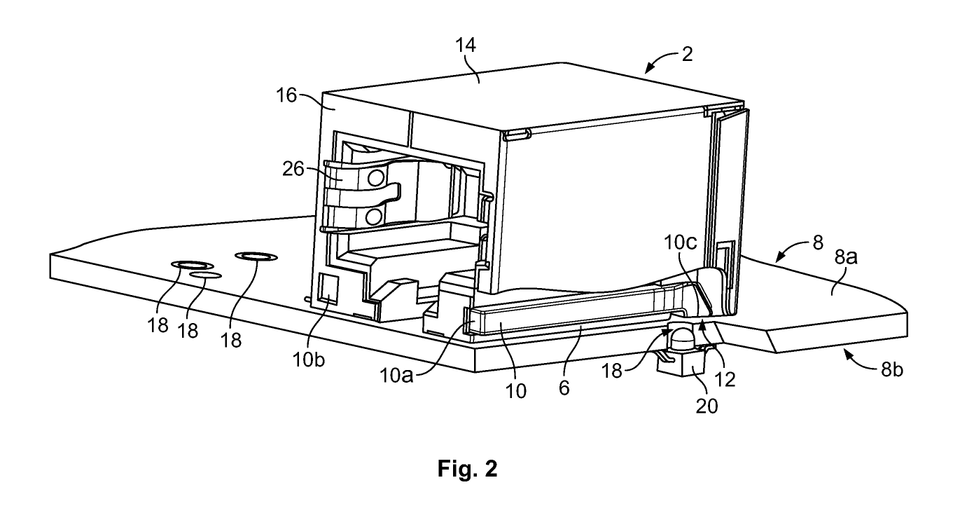

FIG. 2 is a further perspective partially sectional view of the arrangement from FIG. 1.

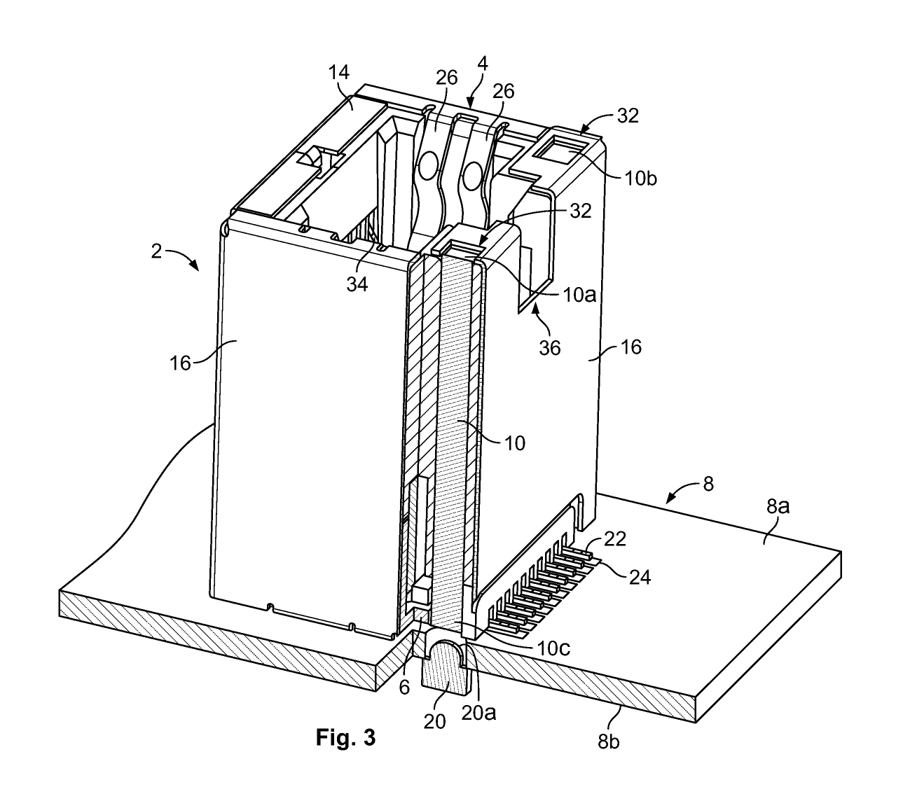

FIG. 3 is a perspective partially sectional view of an alternative exemplary embodiment of an arrangement according to the invention consisting of a printed circuit board, a luminescent element and a connector housing according to the invention.

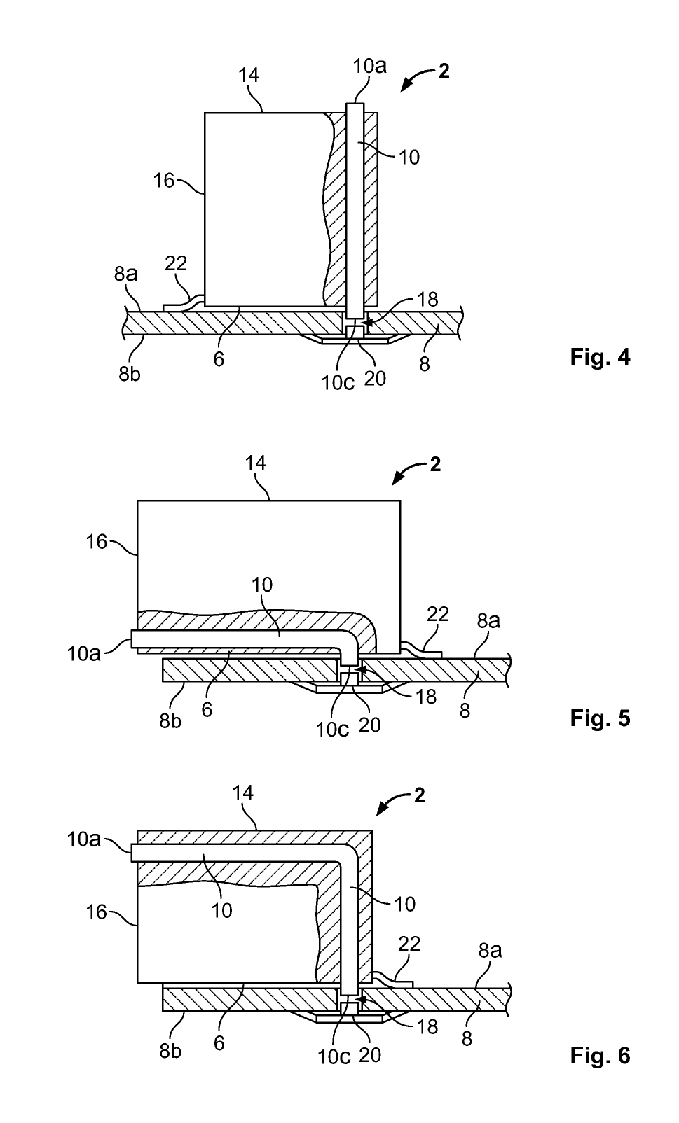

FIG. 4 is a schematic partially sectional view of an arrangement according to the invention with an exemplary embodiment of a connector housing in which the light guide extends to the top of the connector housing.

FIG. 5 is a schematic partially sectional view of an alternative exemplary embodiment, in which the light guide extends to the lower region of one side of the connector housing.

FIG. 6 is a schematic partially sectional view of an alternative exemplary embodiment, in which the light guide extends to the upper region of one side of the connector housing.

FIG. 1 is a perspective partially sectional view of an arrangement according to the invention with a printed circuit board 8, a luminescent element 20 and a connector housing 2, which is surrounded by an electromagnetic screen, in order to screen out possibly troublesome electromagnetic radiation and so improve electromagnetic compatibility. A via 18 is formed in the printed circuit board 8 and penetrates completely through the printed circuit board 8 from the top 8a of the printed circuit board 8 to the bottom 8b thereof. A luminescent element 20 is mounted on the bottom 8b of the printed circuit board 8 in such a way that an upper part 20a of the luminescent element 20 is arranged within the via 18. In the exemplary embodiment of FIG. 1, the luminescent element 20 takes the form of a reverse light-emitting diode, i.e. it outputs radiation on the side facing the printed circuit board 8.

The light-emitting diode 20 is connected electrically via light-emitting diode terminals 30 to conductor tracks, not shown, on the underside 8b of the printed circuit board 8.

A connector housing 2 according to the invention is fitted on the top 8a of the printed circuit board 8. The connector housing 2 is connected electrically by way of electrical terminals 22, which are visible at the right-hand bottom end of the connector housing 2, to conductor tracks, not shown, on the top 8a of the printed circuit board 8. A fixing pin 28, which is passed through a via in the printed circuit board 8, assists in correct alignment of the connector housing 2 on the printed circuit board 8.

On the front side 16 of the connector housing 2 shown on the left in FIG. 1, a connector constructed as a socket 4 is provided for receiving a plug-in element, not shown. On an inner side wall of the socket 4 there is provided a spring element 26 for contacting a shield constructed on the plug-in element.

The plug-in element may comprise a locking lug, in order to fix the plug-in element in the socket 4.

The connector housing 2 has a base 6, which rests on the printed circuit board 8. Above the base 6 the connector housing 2 is shown cut open, such that a first light guide 10 is visible, which extends horizontally inside the connector housing 2 from the front side 16 of the connector housing 2 towards the rear. In the rear region of the connector housing 2 the first light guide 10 is bent downwards and passes through an opening 12 in the base 6 of the connector housing 2.

In the exemplary embodiment shown in FIG. 1, the first light guide 10 ends flush with the bottom of the base 6 provided for mounting on the printed circuit board 8. The connector housing 2 is arranged on the top 8a of the printed circuit board 8 in such a way that the end 10c, extending through the opening 12 in the base 6, of the first light guide 10 is arranged in the printed circuit board 8 directly over the via 18. In this way, radiation emitted by the luminescent elements 20 is absorbed immediately and with low loss by the first light guide 10, passed to an end face 10a of the first light guide 10 arranged on the front side 16 of the connector housing 2 and output there.

In the lower left-hand region of the front side 16 shown at the back in FIG. 1, the end face 10b of a second light guide is visible, which is arranged symmetrically to the first light guide 10 in the connector housing 2. A via 18, not apparent in FIG. 2, is also formed in the printed circuit board 8 under the rear end of the second light guide, not visible in FIG. 2, and a luminescent element 20 is fitted on the bottom 8b of the printed circuit board 8.

FIG. 2 shows the arrangement of FIG. 1 from a slightly different perspective. The features already described in connection with FIG. 1 are provided with the same reference numerals and are not explained again in detail.

Due to the different perspective, the spring element 26 provided on the inner side wall of the socket 4 is particularly easily visible in FIG. 2. A similar spring element 26 is formed on an opposing side wall of the socket 4. The end face 10b of the second light guide is also readily visible in FIG. 2 in the bottom left-hand region of the front side 16.

On the left next to the connector housing 2 further vias 18 are visible in the printed circuit board 8, these being provided for the mounting of further connector housings 2. The vias 18 are designed on the one hand to receive fixing pins 28, on the other hand for feeding through light radiation, which is emitted by further luminescent elements 20, which are mounted, not shown in FIG. 2, on the bottom 8b of the printed circuit board 8.

FIG. 3 is a partially sectional view of an arrangement with an alternative exemplary embodiment of a connector housing 2 according to the invention.

In the connector housing 2 shown in FIG. 3, the socket 4 is formed on the top 14 of the connector housing 2.

The connector housing 2 is connected to electrical conductor tracks 24, which are formed on the top 8a of the printed circuit board 8, via electrical terminals 22 visible in the bottom right-hand region of the connector housing 2.

The connector housing 2 is cut open at its edge shown front right in FIG. 3. This reveals the light guide 10, which extends in a straight line from the base 6, which rests on the printed circuit board 8, to the top 14 of the connector housing 2 and exits at the top 14 of the connector housing 2 through an opening 32. The light guide 10 ends at its lower end 10c flush with the side of the base 6 resting on the printed circuit board 8 above a via 18 formed in the printed circuit board 8. Below the via 18 a luminescent element 20 is arranged on the bottom 8b of the printed circuit board 8, which luminescent element projects with its upper part 20a into the via 18. In this way, the radiation, which is output by the upper part 20a of the luminescent element 20, is transmitted particularly effectively and reliably into the light guide 10. The radiation is guided by the light guide 10 to the end face 10a thereof, which is arranged in the opening 32 in the top 14 of the connector housing 2, and output there.

A similar light guide arrangement is formed in the region of the connector housing 2 shown back right in FIG. 3. Since the connector housing 2 is here shown closed, only the upper end face 10b of the second light guide of this arrangement, is visible here.

The socket 4 formed in the top 14 of the connector housing 2 corresponds to the socket 4 described in FIGS. 1 and 2 and is not therefore explained in detail again. The view illustrated in FIG. 3 additionally shows at least in part contact elements 34 not visible in FIGS. 1 and 2 for bringing about electrical contact with a plug-in element, not shown.

Between the two light guides 10 extending to the top 14 of the connector housing 2, a recess 36 is visible on the right-hand side 16 of the connector housing 2, which recess is formed for receiving a guide lug of the plug-in element, not shown. In particular, the guide lug and the recess 36 are configured in such a way that the guide lug snaps into the recess 36 and thereby locks the plug-in element in the socket 4.

In the exemplary embodiments shown, the connector housing is configured as a surface-mounted (SMT) component. Since the terminals 22, 30 of the luminescent element 20 and of the connector housing 2 are in each case arranged on opposing sides of the printed circuit board 8, the arrangement shown in FIGS. 1 to 3 makes it possible to provide a large voltage distance between the terminals 30 of the luminescent element 20 and the terminals 22 of the connector housing 2 and of the electromagnetic screen. This is advantageous for good electromagnetic compatibility, in particular in the case of line-conducted high voltage pulses.

Since, according to the invention, the luminescent element 20 is not integrated into the connector housing 2, it may be freely selected independently of the connector housing 2. Furthermore, it is easily accessible for inspection, in particular for inspection of solder points after processing, and may be straightforwardly exchanged if necessary.

Since the connector housing 2 and the luminescent element 20 are fitted to different sides of the printed circuit board 8, each side 8a, 8b of the printed circuit board 8 may be produced in each case in a single reflow soldering process. In this way, the printed circuit board 8 may be particularly simply, cheaply and quickly populated.

FIG. 4 is a schematic sectional view of an arrangement with a connector housing 2 according to the invention, in which a light guide 10 extends from the base 6 of the connector housing 2 to the top 14 thereof. This connector housing 2 is also connected to conductor tracks, not shown, on the top 8a of the printed circuit board 8 by way of an electrical terminal 22 shown on the left side 16.

Unlike in the exemplary embodiments shown in FIGS. 1 to 3, in this exemplary embodiment the light guide 10 does not terminate flush with the base 6 of the connector housing 2. Instead, the light guide 10 projects beyond the base 6 of the connector housing 2 into the via 18. In this way, even more effective transmission of the radiation emitted by the luminescent element 20 into the light guide 10 is achieved. Furthermore, a light guide 10 projecting into the via 18 ensures that the light guide 10 is aligned directly over the luminescent element 20.

FIG. 5 shows an alternative exemplary embodiment, in which the light guide 10 extends in the lower region of the connector housing 2 to the front side 16 of the connector housing 2. Here too the rear end of the light guide 10 projects beyond the base 6 of the connector housing 2 into the via 18 formed in the printed circuit board 8 and in this way is aligned directly over the luminescent element 20, which is mounted on the bottom 8b of the printed circuit board 8.

FIG. 6 shows a further alternative exemplary embodiment of a connector housing 2 according to the invention, in which the light guide 10 initially extends upwards in the rear region of the connector housing 2 and then towards the front side 16 of the connector housing 2 in the upper region thereof. Here too the lower end of the light guide 10 projects beyond the base 6 of the connector housing 2 into the via 18 formed in the printed circuit board 8 and in this way is aligned directly over the luminescent element 20, which is mounted on the bottom 8b of the printed circuit board 8.

In the exemplary embodiments shown in FIGS. 4 to 6, the upper or front end of the light guide 10 also projects respectively beyond the top 14 or beyond the front side 16 of the connector housing 2. This makes it possible for the end face 10a of the light guide 10 to terminate flush with a screen element not shown in FIGS. 4 to 6, which may be fitted around the connector housing 2 in order to increase electromagnetic compatibility. A flush-terminating end face 10a makes the light signal output at the end face 10a particularly readily visible from various viewing angles.

### LIST OF REFERENCE SIGNS

2 Connector housing
4 Connector
6 Base
8 Printed circuit board
8a Top of printed circuit board
8b Bottom of printed circuit board
10 Light guide
10a, 10b End face of light guide
10c Lower end of light guide
12 Opening
Top of connector housing
14 Side of connector housing
16 Via
18 Luminescent element
20a Upper part of luminescent element
22 Electrical terminal
24 Electrical conductor track
26 Spring element
28 Fixing pin
30 Light-emitting diode terminal
32 Opening
34 Contact element
36 Recess

1-18. (canceled)

19. A connector housing having
at least one connector for electrical connection with a complementary plug-in element;
a base, which is designed for mounting on a printed circuit board,
a light guide arranged in or on the connector housing;
wherein one end, designed to absorb an optical signal, of the light guide terminates flush with the side of the base provided for mounting on the printed circuit board or projects therebeyond.

20. A connector housing according to claim 19, wherein at least one opening is provided in the base and the light guide extends through the opening.

21. A connector housing according to claim 20, wherein the light guide fits flush into the opening, such that the opening is completely closed and sealed by the light guide.

22. A connector housing according to claim 19, wherein the base is provided with at least one electrical terminal for electrical contacting with conductor tracks arranged on the printed circuit board.

23. A connector housing according to claim 19, wherein the connector housing takes the form of a surface-mounted (SMT) component.

24. A connector housing according to claim 19, wherein the at least one connector takes the form of a socket for receiving a complementary plug connector.

25. A connector housing according to claim 24, wherein the connector housing (2) takes the form of an RJ11 or an RJ45 connector housing.

26. A connector housing according to claim 19, wherein the light guide extends to a top of the connector housing opposite the base.

27. A connector housing according to claim 19, wherein the light guide is bent and extends to one side of the connector housing.

28. A connector housing according to claim 19, wherein a plurality of light guides are provided in or on the connector housing.

29. A connector housing according to claim 19, wherein a plurality of connectors are provided in the connector housing.

30. An arrangement, comprising:
a printed circuit board with at least one via;
at least one luminescent element for emitting electromagnetic radiation;
at least one connector housing with at least one light guide for receiving and guiding electromagnetic radiation;
wherein the connector housing is arranged in such a way on a first side of the printed circuit board and the luminescent element is arranged in such a way on a second side of the printed circuit board that the radiation emitted by the luminescent element passes at least in part through the via in the printed circuit board into the light guide.

31. An arrangement according to claim 30, wherein at least one of the connector housing and the luminescent element takes the form of a surface-mounted (SMT) component.

32. An arrangement according to claim 30, wherein the luminescent element is a light-emitting diode.

33. An arrangement according to claim 32, wherein the light-emitting diode takes the form of a reverse light-emitting diode.

34. An arrangement according to claim 30, wherein the connector housing comprises a plurality of light guides and a plurality of luminescent elements are provided and wherein the light guide and the luminescent elements are arranged in such a way that each luminescent element radiates into a different light guide.

35. An arrangement according to claim 30, wherein the light guide is arranged at least in part within the via formed in the printed circuit board.

36. An arrangement according to claim 30, wherein the luminescent element is arranged at least in part within the via formed in the printed circuit board.
